(19) United States
(12) Patent Application Publication
(10) Pub. No.: US 2014/0103594 A1
(43) Pub. Date: Apr. 17, 2014

(54) COUPLING FOR USE WITH A HOLDER

(71) Applicant: Graham Noel Drummond, Nelson (NZ)

(72) Inventor: Graham Noel Drummond, Nelson (NZ)

(21) Appl. No.: 14/123,450

(22) PCT Filed: Jun. 1, 2012
(86) PCT No.: PCT/NZ2012/000080

§ 371 Date: Dec. 2, 2013

(30) Foreign Application Priority Data
Jun. 2, 2011 (NZ) 593230

(51) Int. Cl. B25B 11/00

(52) U.S. Cl. CPC B25B 11/00
USPC 269/134

(57) ABSTRACT

A coupling for use with a holder. A tool that can be attached to a holder using such a coupling. The coupling comprises a slot to hold the holder in a retaining position, a channel defining a pathway which permits movement of the holder from an outer peripheral edge of the coupling into the retaining position, and having a cam surface on its outer peripheral edge about which the coupling can be moved to facilitate movement of the holder out of the retaining position into alignment with the channel for removal.

This invention relates to a coupling for use with a holder. The invention also relates to a tool that can be attached to a holder using such a coupling.

As used throughout the specification, the term “holder” is intended to refer to any rod like element supported in relation to a surface. The holder may be attached to the surface by a support post located at or near each end of the holder. Preferably the holder is biased at least at one end, for example, by means of a spring. In one embodiment of the invention, the holder is the spring-biased retaining bar of the cutting board described in PCT International Application No. PCT/NZ2010/000140, which is incorporated by reference.

### BACKGROUND

The world is experiencing an increasing ageing population and a growing number of people living with a physical disability or illness, affecting their ability to maintain their independence at home. As an example, the everyday task of meal preparation is often made more difficult by a persons inability to grip, hold and effectively operate an item of kitchen equipment or tool as a result of their disability or ailment.

There is currently a large range of tools on the market, but the vast majority do not address the very real issue of how to hold the tool effectively, if a person has limited strength or ability. Some current tools involve the use of a fixing device such as a clamp or bracket to hold the tool in position during use, but a disabled user often does not possess the dexterity to operate the fixing device.

### SUMMARY OF THE INVENTION

According to a first aspect of the invention, there is provided a coupling for use with a holder, the coupling comprising a slot to hold the holder in a retaining position, a channel defining a pathway which permits movement of the holder from an outer peripheral edge of the coupling into the retaining position, and having a cam surface on its outer peripheral edge about which the coupling can be moved to facilitate movement of the holder out of the retaining position into alignment with the channel for removal.

In one embodiment, the holder is a spring-biased retaining bar of a cutting board. In another embodiment, the holder is a rack for attaching tools onto a vertical or other surface, for example but not limited to, a kitchen rack for attaching kitchen tools for storage.

The holder can move along the pathway of the channel and drop into the retaining position in the slot, movement of the coupling about a cam surface causing the holder to drop out of the slot and into the channel.

Expediently the channel is inclined at a positive angle from the outer peripheral edge of the coupling.

In one embodiment, the channel intersects the midpoint of the slot to form a generally T-shaped configuration.

The coupling may have more than one cam surface.

In one embodiment, the holder is a biased holder. The biased holder can be a spring-biased retaining bar.

According to a second aspect of the invention, there is provided a tool comprising a coupling as described above.

The tool may comprise more than one coupling.

In one embodiment, the tool is a kitchen tool, for example, a food grater, shredder, slicer or press.

### DETAILED DESCRIPTION OF THE INVENTION

A number of embodiments of the coupling will now be described, by way of example only, with reference to the accompanying drawings in which:

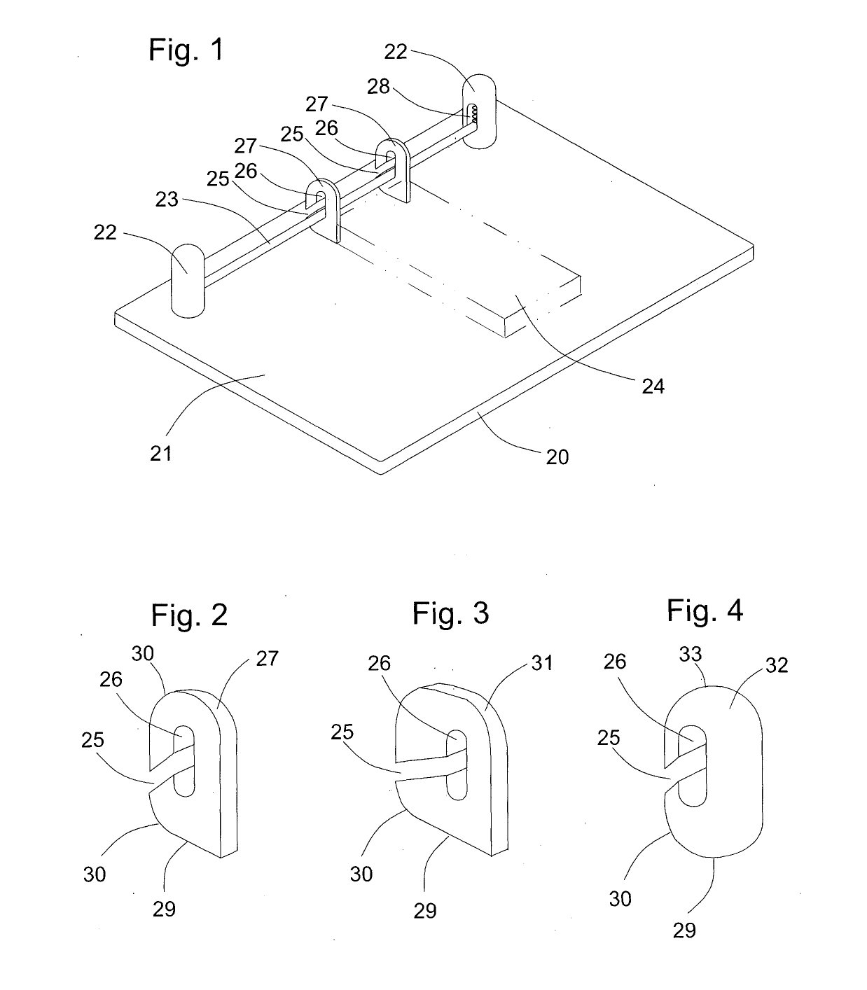

FIG. 1 is an overall perspective view of a spring-biased holder of a cutting board in a retaining position in a pair of couplings, the couplings being attached to a tool shown in phantom.

FIG. 2 is a perspective view of one of the couplings shown in FIG. 1.

FIG. 3 is a perspective view of a coupling with an extended foot in accordance with a second embodiment.

FIG. 4 is a perspective view of a compact coupling in accordance with a third embodiment.

As shown in FIGS. 1 and 2, the invention relates to a coupling 27 for use with a holder 23, the coupling comprising a slot 26 to hold the holder in a retaining position (as shown in FIG. 1), a channel 25 defining a pathway which permits movement of the holder from an outer peripheral edge of the coupling into the retaining position, and having a cam surface 30 on its outer peripheral edge about which the coupling can be moved to facilitate movement of the holder out of the retaining position into alignment with the channel for removal.

The holder 23 can move along the pathway of the channel 25 and drop into the retaining position in the slot 26, movement of the coupling 27 about a cam surface 30 causing the holder to drop out of the slot and into the channel.

The cutting board 20 shown in FIG. 1 is as described in PCT International Application No. PCT/NZ2010/000140 and provides a ready made stable base to which an array of tools can be attached by means of one or more couplings 27 incorporated into the design of the tool or retrofitted onto the tool. This is achieved by the spring-biased retaining bar 23 of the cutting board engaging with the vertical slot 26 of the coupling by means of the coupling's inclined channel 25. Once the retaining bar is located in the bottom of the vertical slot, the tool is held firmly in position, freeing up the hands of the operator from needing to hold the tool.

The tool 24 is disengaged from the cutting board 20 by lifting the tool using an upward and forward motion in which the coupling 27 is moved about the two cam surfaces 30 and pivoted around the retaining bar 23 until the tool disengages from the cutting board, assisted by the downward bias on the retaining bar. This can all be achieved using one hand. The relationship between the cutting board and the coupling is critical to the performance of the coupling and the ability for the tool to be attached and detached easily with very little effort. This is achieved by the corresponding dimensions of the vertical slot 28 in the support posts 22 of the cutting board and the vertical slot 26 in the coupling. The radius of the quarter circular corner of the cam surfaces, combined with the interaction of the retaining bar of the cutting board with the inclined channel 25 and vertical slot of the coupling is determined by the dimensions of the components of the cutting board.

In the embodiment of the invention described herein, the coupling 27 provides a simple to use, low cost, means of attaching a kitchen tool 24 to a cutting board 20, providing a robust, stable base from which a range of food preparation tasks can be performed without the need to hold the tool by hand.

The coupling 27 can be incorporated into the tool 24 at the design and manufacture stage, or can be fitted to an existing tool later by means of fasteners. A coupling may include additional design features making it a tool in its own right.

FIG. 1 is an overall perspective view showing, in accordance with one embodiment, a cutting board 20 wherein a tool 24 is placed on a top surface 21 of the cutting board and attached to a spring-biased retaining bar 23 by means of a single coupling 27 or pair of couplings 27 and held in position by the retaining bar. In the embodiment shown, the coupling has a rectangular cross section and made of thermoplastic. However, the coupling could have a differently shaped cross section, such as, round, oval, square, and be different sizes and made of different materials, such as, stainless steel. I presently contemplate the coupling is attached to the tool by means of fasteners or incorporated into the new tool at the time of design and manufacture or has features incorporated into the coupling itself.

FIG. 2 is a perspective view showing one of the couplings 27 in FIG. 1. I presently contemplate a pair of quarter circular corner cam surfaces 30 each having a radius of 19 mm, however it could have a different radius. I presently contemplate an inclined channel 25 has a width of 8 mm, intersecting at the midpoint of a vertical slot 26, however it could have a different width. I presently contemplate the vertical slot 26 has a width of 8 mm and a height of 25 mm, however it could have a different width and height. I presently contemplate the bottom apex of the vertical slot 26 has a distance of 15 mm from a base 29 of the coupling 27, however it could have a different distance. The bottom lip of the inclined channel 25 is the same height from the base 29 as the bottom apex of the vertical slot 26. I presently contemplate the coupling has a rectangular cross section and made of thermoplastic, however it could have a differently shaped cross section, such as, round, oval, square, and be different sizes and made of different materials, such as, stainless steel. The final dimensions of the quarter circular corner cam surfaces, the inclined channel and the vertical slot are determined by the dimensions of the cutting board.

FIG. 3 is a perspective view showing a coupling 31 with an extended foot in accordance with a second embodiment. I presently contemplate the quarter circular corner cam surface 30 has a radius of 15 mm, however it could have a different radius. I presently contemplate the inclined channel 25 has a width of 8 mm, intersecting at the midpoint of the vertical slot 26, however it could have a different width. I presently contemplate the vertical slot has a width of 8 mm and a height of 25 mm, however it could have a different width and height. I presently contemplate the bottom apex of the vertical slot has a distance of 15 mm from the base 29 of the coupling, however it could have a different distance. The bottom lip of the inclined channel is the same height from the base as the bottom apex of the vertical slot. I presently contemplate the distance between the bottom lip of the inclined channel to the bottom apex of the vertical slot is 33 mm, however it could have a different distance. I presently contemplate the coupling has a rectangular cross section and made of thermoplastic, however it could have a differently shaped cross section, such as. round, oval, square. and be different sizes and made of different materials, such as, stainless steel. The final dimensions of the quarter circular corner cam surface, the inclined channel and the vertical slot are determined by the dimensions of the cutting board.

FIG. 4 is a perspective view showing a compact coupling 32 in accordance with a third embodiment. I presently contemplate the quarter circular corner cam surface 30 has a radius of 19 mm, however it could have a different radius. I presently contemplate a semi circular top cam surface 33 has a radius of 19 mm, however it could have a different radius. I presently contemplate the inclined channel 25 has a width of 8 mm, intersecting at the midpoint of the vertical slot 26, however it could have a different width. I presently contemplate the vertical slot has a width of 8 mm and a height of 25 mm, however it could have a different width and height. I presently contemplate the bottom apex of the vertical slot has a distance of 15 mm from a base 29 of the coupling, however it could have a different distance. The bottom lip of the inclined channel is the same height from the base of the coupling as the bottom apex of the vertical slot. I presently contemplate the leading point of the bottom lip of the inclined channel to the bottom apex of the vertical slot has a distance of 19 mm, however it could have a different distance. I presently contemplate the coupling has a round cross section with a diameter of 38 mm and made of thermoplastic, however, it could have differently shaped cross sections, such as, rectangular, oval, square, and be different sizes and made of different materials, such as, stainless steel. The final dimensions of the quarter circular corner cam surface, the inclined channel and the vertical slot are determined by the dimensions of the cutting board.

A tool incorporating one or more couplings in accordance with one embodiment, is placed on the top surface 21 of the cutting board 20 with the coupling(s) adjacent the retaining bar 23. The tool is pushed toward the retaining bar until the opening of the inclined channel 25 in the coupling engages the retaining bar. The tool is pushed further toward the retaining bar, causing the bar to travel up the inclined channel until it intersects with the vertical slot 26, at which point it drops to the bottom of the vertical slot, aided by the downward bias on the retaining bar. The tool is now held in position by the retaining bar, preventing it from moving in a backward or forward direction, but maintains the ability to be slid longitudinally along the retaining bar. The vertical slot in the coupling corresponds with the vertical slot 28 in the support posts 22 of the cutting board 20 therefore enabling the retaining bar to continue to move in an upward and downward direction unimpeded by the coupling(s).

One embodiment of the coupling enables the tool 24 to be removed from the cutting board 20 by raising the tool from the top surface 21, causing the coupling(s) to pivot around the retaining bar 23. The tool is pushed past the vertical position until it causes the retaining bar to travel down the vertical slot, coming to rest in the top of the inclined channel 25, with an audible click. The tool is then tilted backward, causing the retaining bar to travel down the inclined channel until the tool disengages from the retaining bar and is returned to the top surface of the cutting board. While the tool is attached to the cutting board the tool is able to be pivoted vertically on the retaining bar from the top surface of the cutting board, while remaining horizontally perpendicular to the retaining bar.

The embodiment of the coupling 31 shown in FIG. 3 as having an extended foot enables the tool 24 to be removed from the cutting board 20 by raising the tool from the top surface 21, causing the coupling(s) to pivot around the retaining bar, until reaching a vertical position on the cutting board. The tool is then pulled backward causing the retaining bar 23 to travel along the vertical slot 26 before dropping into the top of the inclined channel 25 with an audible click. The tool is then tilted backward toward the top surface of the board, causing the retaining bar to travel down the inclined channel and the tool disengages from the retaining bar and returns to the top surface of the cutting board. While the tool is attached to the cutting board the tool is able to be pivoted vertically on the retaining bar from the top surface of the cutting board, while remaining horizontally perpendicular to the retaining bar. As the tool is progressively pivoted upward from the top surface, engaging the quarter circular corner of the cam surface 30 it causes the biased retaining bar to move vertically and apply a progressive downward pressure on the bottom of the tool, resulting in a clamping action.

Accordingly, the coupling of the invention provides several substantial advantages to the user of a tool, including:
To provide a means by which kitchen equipment and tools can be attached to a suitable stable base to enable a person to use the tool without having to hold the tool in place by hand.
The coupling has no moving parts, no adjustment required and can be retrofitted to an existing tool or incorporated into a new tool at the time of design and manufacture. The coupling can include an additional design feature effectively making it a new tool in its own right.
A tool can be attached and detached from the cutting board using one hand and with minimal effort. The motion of the retaining bar is not impeded when a tool is attached because the vertical slot in the coupling(s) replicates that of the vertical slot in the support posts of the cutting board and therefore do not affect the action of the retaining bar.
The coupling holds a tool firmly in position on the top surface of the cutting board or can allow a tool to be pivoted upward from the bar. A tool incorporating a coupling with an extended foot and pivoted upwards from the retaining bar can be employed as a clamp type arrangement to further assist a disabled user to hold an item of food on the cutting board.
The tool is engaged and disengaged from the retaining bar with an audible click caused by the coupling(s) disengaging from the biased retaining bar returning to the bottom of the slot in the support post on the cutting board. This sound assists a visually impaired user to know when the tool has been successfully attached or is ready to be detached from the cutting board.

While some preferred aspects of the invention have been described by way of example, it should be appreciated that modifications and/or improvements can occur without departing from the scope of the invention as set out in this specification.

The terms comprise, comprises, comprising, or comprised, if and when used herein, should be interpreted non-exclusively, that is, as conveying “consisting of or including”.

What is claimed is:

1. A coupling for use with a holder, the coupling comprising a slot to hold the holder in a retaining position, a channel defining a pathway which permits movement of the holder from an outer peripheral edge of the coupling into the retaining position, and having a cam surface on its outer peripheral edge about which the coupling can be moved to facilitate movement of the holder out of the retaining position into alignment with the channel for removal.

2. A coupling according to claim 1 wherein the holder can move along the pathway of the channel and drop into the retaining position in the slot, movement of the coupling about a cam surface causing the holder to drop out of the slot and into the channel.

3. A coupling according to claim 1 wherein the channel is inclined at a positive angle from the outer peripheral edge of the coupling.

4. A coupling according to claim 1 wherein the channel intersects the midpoint of the slot to form a generally T-shaped configuration.

5. A coupling according to claim 1 wherein the coupling has more than one cam surface.

6. A coupling according to claim 1 wherein the holder is a biased holder.

7. A coupling according to claim 6 wherein the biased holder is a spring-biased retaining bar.

8. A tool comprising a coupling according to claim 1.

9. A tool according to claim 8 wherein the tool comprises more than one coupling.

10. A tool according to claim 8 wherein the tool is a kitchen tool.

11. A tool according to claim 10 wherein the tool is a food grater, shredder, slicer or press.
